(19) United States
(12) Patent Application Publication
(10) Pub. No.: US 2006/0192839 A1
(43) Pub. Date: Aug. 31, 2006

(54) Method and apparatus for measuring optical density of image printed on medium

(75) Inventors: Hyoung-il Kim, Suwon-si (KR); Kyung-pyo Kang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/320,729

(22) Filed: Dec. 30, 2005

(30) Foreign Application Priority Data
Feb. 25, 2005 (KR) 10-2005-0016177

(51) Int. Cl. B41J 2/36

(52) U.S. Cl. 347/188

(57) ABSTRACT

A method and apparatus are provided for measuring the optical density of an image printed on a medium in an image forming apparatus. The method includes the steps of reading reference information from a memory, measuring the amount of light reflected from a medium on which a target image is printed by applying light to the medium, and calculating the optical density of the target image using the reference information and the measured amount of light reflected from the medium. Accordingly, it is possible to precisely measure the optical density of an image printed on the medium without the aid of an additional optical density measurement device and easily reduce differences or variations in the quality of printing between image forming apparatuses.

### CROSS-REFERENCE TO RELATED PATENT APPLICATION

This application claims the benefit under 35 U.S.C. §119(a) of Korean Patent Application No. 10-2005-0016177, filed in the Korean Intellectual Property Office on Feb. 25, 2005, the entire disclosure of which is incorporated herein by reference.

### BACKGROUND OF THE INVENTION

1. Field of the Invention

The present invention relates to a method and apparatus for measuring the optical density of an image printed on a medium in an image forming apparatus. More particularly, the present invention relates to a method and apparatus for measuring the optical density of an image printed on a medium by measuring the amount of light reflected from a medium and calculating the optical density of an image printed on the medium using the measured amount of light and an equation.

2. Description of the Related Art

Generally, image forming apparatuses convert a document written by a user via an application program or an image photographed by the user into encoded data. Then, the image forming apparatuses output the data onto media thereby making it visible to the user.

Recently, many printing apparatuses have been developed to print high quality images. For example, thermal transfer printing apparatuses can print an image by applying heat onto an ink ribbon contacting a medium using a thermal printhead, and thus, transfer ink on the ink ribbon onto the medium. Alternatively, thermal transfer printing apparatuses can print an image by applying heat onto a medium, on which an ink layer that produces a predetermined color by reacting to heat is formed, through a thermal printhead.

Thermal transfer printing apparatuses generate signals for controlling the driving of a thermal printhead according to the optical density of an image to be printed. However, images printed in the same color by image forming apparatuses of the same type may not have the same optical density because of slight differences in the elements of the image forming apparatuses.

Therefore, it is necessary to eliminate print deviations among the image forming apparatuses by measuring the optical densities of images printed on a medium by the image forming apparatuses. Conventionally, the optical density of an image printed on a medium is measured using an additional optical density measurement device, which undesirably incurs additional costs.

Accordingly, a need exists for an effective and efficient system and method for measuring the optical densities of images printed on a medium by the image forming apparatuses.

### SUMMARY OF THE INVENTION

Embodiments of the present invention substantially solve the above and other problems, and provide a method and apparatus for measuring the optical density of an image printed on a medium by measuring the amount of light reflected from a medium using a sensor installed in an image forming apparatus.

According to an aspect of embodiments of the present invention, a method is provided for measuring the optical density of an image printed on a medium. The method comprises the steps of reading reference information from a memory, the reference information specifying the relationship between the amount of light reflected from a medium and the optical density of an image printed on the medium, measuring the amount of light reflected from a medium on which a target image is printed by applying light to the medium, and calculating the optical density of the target image using the reference information and the measured amount of light reflected from the medium.

The reference information may comprise an equation established based on the amount of light reflected from the medium and the optical density of the image printed on the medium.

The reference information may comprise a lookup table in which the amounts of light reflected from a plurality of images printed on the medium and the optical densities of the images are stored.

The method may also include the steps of establishing an equation based on the amount of light reflected from the medium and the optical density of the image printed on the medium, and storing the equation in the memory.

The step of establishing the equation may comprise the steps of measuring the amount of light reflected from a sample medium by applying light to the sample medium, and establishing an equation based on the measured amount of light reflected from the sample medium and the optical density of a sample image printed on the sample medium.

The step of establishing the equation may comprise the steps of measuring the amount of light reflected from a sample medium by applying light to the sample medium on which sample images are printed, measuring the optical density of the sample images, and establishing an equation based on the measured amount of light reflected from the sample medium and the measured optical density of the sample image printed on the sample medium using a curve fitting method.

The target image may be printed in a region of the sample medium where no sample image is printed.

The amount of light reflected from the medium may be measured using a reflective optical sensor.

According to another aspect of embodiments of the present invention, an apparatus is provided for measuring the optical density of an image printed on a medium. The apparatus comprises a sensor, which measures the amount of light reflected from the medium on which a target image is printed by applying light to the medium, a memory, which stores reference information specifying the relationship between the amount of light reflected from a medium and the optical density of an image printed on the medium, and an optical density calculation unit, which calculates the optical density of the target image using the reference information and the measured amount of light reflected from the medium.

The reference information may comprise an equation established based on the amount of light reflected from the medium and the optical density of the image printed on the medium.

The reference information may comprise a lookup table in which the amount of light reflected from the medium and the optical density of the image printed on the medium are stored.

The apparatus may also comprise an equation generation unit, which establishes an equation based on the amount of light reflected from the medium and the optical density of the image printed on the medium and stores the equation in the memory.

The equation generation unit may receive from the sensor the amount of light reflected from a sample medium that is measured by applying light to the sample medium, and establish an equation based on the measured amount of light reflected from the sample medium and the optical density of a sample image printed on the sample medium.

The equation generation unit may establish the equation based on the measured amount of light reflected from a sample medium and the optical density of a sample image printed on the sample medium.

The target image may be printed in a region of the sample medium where no sample image is printed.

According to another aspect of embodiments of the present invention, an image forming apparatus is provided that prints an image on a medium. The apparatus comprises a data input unit, which receives image data to be printed, a control unit, which generates a print control signal based on the received image data, a print unit, which receives the print control signal and the received image data and prints a target image on the medium, and a sensor, which measures the amount of light reflected from the medium by applying light onto the medium on which the target image has been printed. The control unit comprises a memory, which stores an equation established based on the amount of light reflected from a medium and the optical density of an image printed on the medium, and an optical density calculator, which calculates the optical density of the target image using the equation stored in the memory and the measured amount of light reflected from the medium.

The apparatus may also comprise an equation generation unit, which receives from the sensor the amount of light reflected from the medium that is measured by applying light to the medium, and establishes an equation based on the measured amount of light reflected from the medium and the optical density of the image printed on the medium.

According to another aspect of embodiments of the present invention, a computer-readable recording medium is provided for storing a computer program for executing a method of measuring the optical density of an image printed on a medium.

### BRIEF DESCRIPTION OF THE DRAWINGS

The above and other features and advantages of the present invention will become more apparent by describing in detail exemplary embodiments thereof with reference to the attached drawings, in which:

FIG. 1 is a perspective view illustrating an image forming apparatus using a method of measuring the optical density of an image printed on a medium according to an exemplary embodiment of the present invention;

FIG. 2 is a block diagram illustrating an image forming apparatus having an apparatus for measuring the optical density of an image printed on a medium according to an exemplary embodiment of the present invention;

FIG. 3 is a diagram illustrating an exemplary sample medium used for establishing an equation based on the amount of light reflected and the optical density of an image printed on a medium according to an embodiment of the present invention;

FIG. 4 is a graph illustrating exemplary output values of a sensor that measures the amount of light reflected for the images printed on the sample medium of FIG. 3;

FIG. 5 is a graph illustrating exemplary optical densities of the images printed on the sample medium of FIG. 3;

FIG. 6 is a graph illustrating exemplary digitalized output values of a sensor that measures the amount of light reflected for the images printed on the sample medium of FIG. 3;

FIG. 7 is a graph illustrating an exemplary method of establishing an equation using the sample medium of FIG. 3;

FIG. 8 is a graph illustrating exemplary results of calculating the optical densities of images printed on a medium using the equation of FIG. 7;

FIG. 9 is a flowchart illustrating a method of measuring the optical density of an image printed on a medium according to an exemplary embodiment of the present invention; and

FIG. 10 is a flowchart illustrating a method of measuring the optical density of an image printed on a medium by establishing an equation based on the amount of light reflected from a sample medium and the optical density of a sample image printed on the sample medium, according to an exemplary embodiment of the present invention.

Throughout the drawings, like reference numerals will be understood to refer to like parts, components and structures.

### DETAILED DESCRIPTION OF THE EXEMPLARY EMBODIMENTS

Embodiments of the present invention will now be described more fully with reference to the accompanying drawings in which exemplary embodiments of the invention are shown.

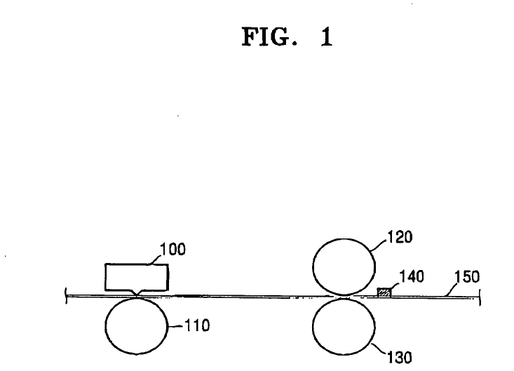

FIG. 1 is a perspective view illustrating an image forming apparatus using a method of measuring the optical density of an image printed on a medium according to an exemplary embodiment of the present invention. Referring to FIG. 1, the image forming apparatus comprises a thermal transfer head 100, a platen roller 110, a slave roller 120, a driving roller 130, and a sensor 140. The operation of the image forming apparatus will be described in greater detail below with reference to FIG. 9.

A printing method of the image forming apparatus will now be described in detail. The driving roller 130 transfers a medium 150 while rotating by engagement with a motor (not shown), which is a driving source. The slave roller 120 engages the driving roller 130 through the medium 150 located therebetween, and transfers the medium 150 while rotating. The thermal transfer head 100 applies heat to the medium 150 in order to print an image. The platen roller 110 faces towards the thermal transfer head 100 with the medium 150 located therebetween, supports the medium 150 so that a predetermined color can be realized on the medium 150 by the thermal transfer head 100 when heat is applied to the medium 150 by the thermal transfer head 100, and rotates when the medium 150 is transferred. The thermal transfer head 100 preferably prints yellow Y, magenta M, and cyan C colors by applying heat to the medium 150, but is not limited thereto. Any number of colors or color combinations can be provided.

The medium, on which an image is to be printed, is transferred toward the thermal transfer head 100 when picked up due to the rotation of the driving roller 130. Thereafter, an image is printed on the medium 150 in the above-described manner. A method of measuring the optical density of an image printed on the medium 150 will now be described in greater detail with reference to FIG. 9.

FIG. 9 is a flowchart illustrating a method of measuring the optical density of an image printed on a medium according to an exemplary embodiment of the present invention. Referring to FIGS. 1 and 9, in operation 900, the medium 150 is transferred in an opposite direction to a direction in which it has been transferred due to the rotation of the driving roller 130, and the sensor 140 applies light to the medium 150. In operation 910, the sensor 140 senses (or measures) light reflected from the medium 150 and outputs the amount of light reflected from the medium 150 as an output. The sensor 140 is preferably already included in the image forming apparatus in order to control the transfer of the medium 150, and particularly, is already included the image forming apparatus in order to detect an edge of the medium 150 and thus, calculate a print starting point. As such, an additional sensor is not required for implementing embodiments of the present invention. The sensor 140 is preferably a reflective optical sensor, but is not limited thereto.

In operation 920, the optical density of an image printed on the medium 150 is calculated using an equation established based on the optical density of the printed image and the amount of light reflected from the medium 150 measured in operation 910.

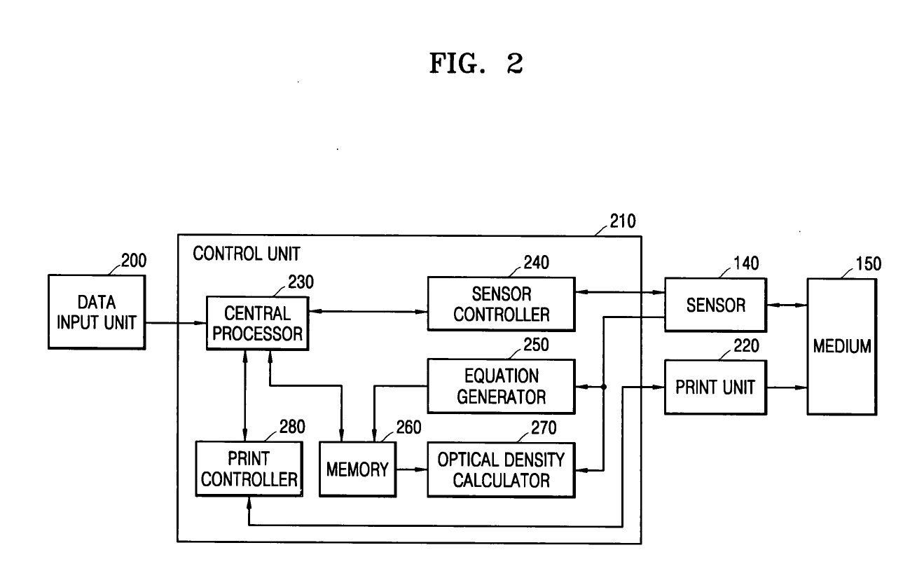

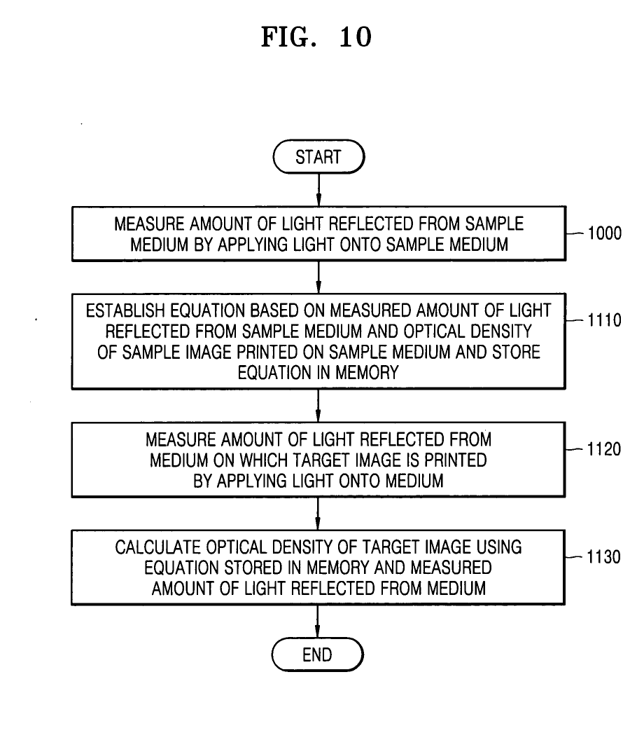

FIG. 2 is a block diagram illustrating an image forming apparatus having an apparatus for measuring the optical density of an image printed on a medium according to an exemplary embodiment of the present invention. Referring to FIG. 2, the image forming apparatus comprises a data input unit 200, a control unit 210, a sensor 140, and a print unit 220. The control unit 210 comprises a central processor 230, a sensor controller 240, an equation generator 250, a memory 260, an optical density calculator 270, and a print controller 280. The operation of the image forming apparatus will be described in greater detail below with reference to FIG. 10.

The data input unit 200 receives image data to be printed from a personal computer (PC), a digital camera, or a memory card (not shown), and the control unit 210 generates control signals for driving the print unit 220 based on the received image data. The print unit 220 receives the control signals and prints an image (hereinafter referred to as a target image) whose optical density preferably needs to be measured on a predetermined medium. The central processor 230 included in the control unit 210 controls the print controller 280, which generates print control signals, the sensor controller 240, the equation generator 250, and the optical density calculator 270, according to a control program stored in the memory 260.

A method of measuring the optical density of an image printed on the predetermined medium using the control unit 210 and the sensor 140 will now be described in greater detail.

A sample medium used for establishing an equation based on the amount of light reflected from the predetermined medium and the optical density of an image printed on the predetermined medium is provided. Sample images are printed on the sample medium, and the optical densities of the sample images are stored in the memory 260. FIG. 10 is a flowchart illustrating a method of measuring the optical density of an image printed on a medium by establishing an equation based on the amount of light reflected from a sample medium and the optical density of a sample image printed on the sample medium, according to an exemplary embodiment of the present invention. Referring to FIGS. 1, 2 and 10, in operation 1000, the sensor 140 applies light onto the sample medium under the control of the sensor controller 240, senses light reflected from the sample medium, and measures the amount of light reflected from the sample medium.

In operation 1100, the equation generator 250 establishes an equation using the measured amount of light reflected from the sample medium and the optical densities of the sample images printed on the sample medium stored in the memory 260, and stores the equation in the memory 260. The equation generator 250 preferably establishes the equation using a curve fitting method, but is not limited thereto. The equation is preferably a quadratic equation having the amount of light reflected from the sample medium as a variable, but is not limited thereto.

In operation 1120, when the predetermined medium on which a target image is printed is provided to the image forming apparatus, the sensor 140 applies light to the predetermined medium, senses light reflected from the predetermined medium, and measures the amount of light reflected from the predetermined medium.

In operation 1130, the optical density calculator 270 receives the measured amount of light reflected from the predetermined medium from the sensor 140, reads the equation from the memory 260, and calculates the optical density of the target image printed on the predetermined medium by substituting the measured amount of light reflected from the predetermined medium into the equation.

Preferably, various reflected light amounts and respective optical densities are stored in the memory 260 as a lookup table, but the lookup table is not limited thereto. In a case where the lookup table is stored in the memory 260, the optical density calculator 270 calculates the optical density of the target image printed on the predetermined medium by reading an optical density corresponding to the measured amount of light reflected from the predetermined medium from the lookup table.

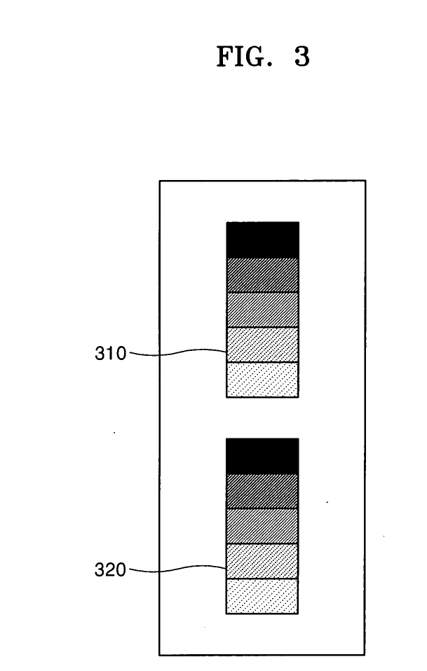

FIG. 3 is a diagram illustrating an exemplary sample medium according to an embodiment of the present invention. Referring to FIG. 3, the sample medium can be divided into two regions, for example, a sample image printing region 310, in which 5 sample images respectively having cyan densities of 100%, 80%, 60%, 40%, and 20% are printed, and an empty region 320, in which target images are to be printed.

A method of measuring the optical density of an image printed on a medium using the image forming apparatus of FIG. 1 and the sample medium of FIG. 3 according to an exemplary embodiment of the present invention will now be described in greater detail.

When the sample medium is picked up, it is transferred toward the thermal transfer head 100 due to the rotation of the driving roller 130, and 5 target images are printed in the empty region 320 of the sample medium. The target images have different optical densities, as shown in FIG. 3. The sample medium on which the 5 target images are printed is transferred in an opposite direction to a direction in which it has been transferred due to the rotation of the driving roller 130.

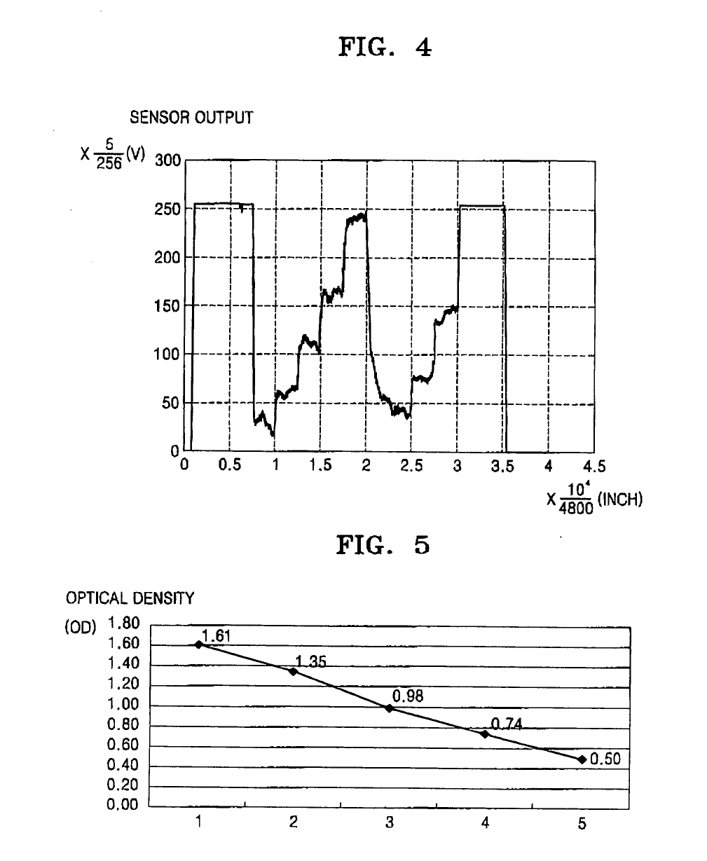

The sensor 140 applies light onto the sample medium, senses light reflected from the sample medium, and outputs the amount of light reflected from the sample medium as an output. FIG. 4 is a graph illustrating exemplary output values of the sensor 140 that measures the amount of light reflected from the sample medium according to an embodiment of the present invention. The vertical axis of FIG. 4 denotes sensor output, and the horizontal axis denotes sample images from darkest to lightest. Referring to FIG. 4, output values of the sensor 140 corresponding to the 5 sample images printed in the sample image printing region 310 are different from one another, and output values of the sensor corresponding to the 5 target images printed in the empty region 320 are also different from one another.

FIG. 5 is a graph illustrating exemplary optical densities of the 5 sample images printed on the sample medium of FIG. 3 according to an embodiment of the present invention. The vertical axis of FIG. 5 denotes optical density, and the horizontal axis denotes sample images from darkest to lightest. The optical densities of the sample images are measured in advance by using an additional optical density measurement device and are then stored in the memory 260 of FIG. 1.

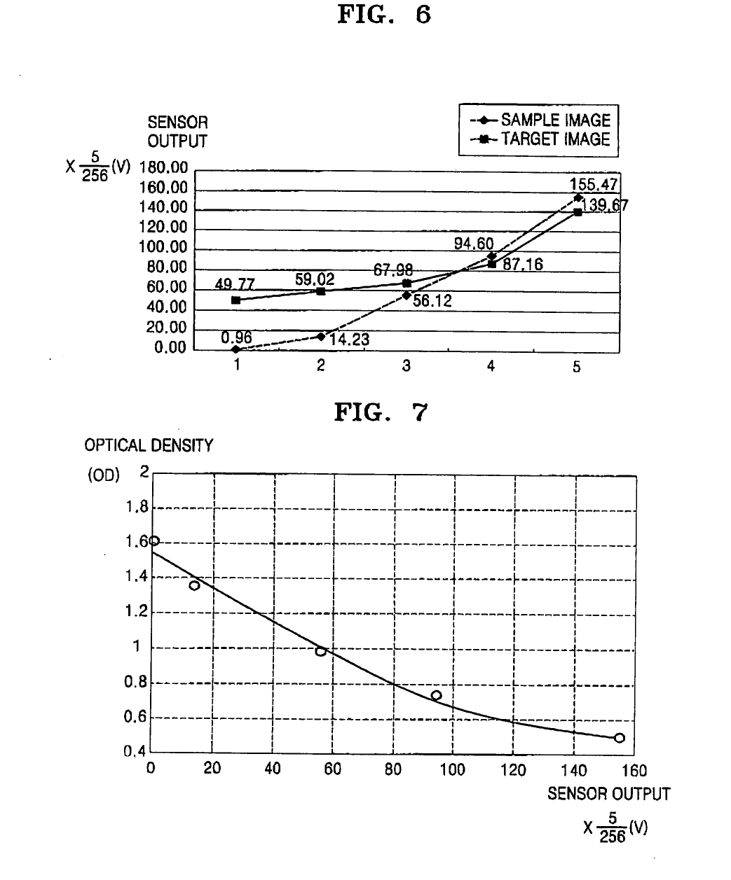

FIG. 6 is a graph illustrating exemplary digitalized output values of the sensor 140 indicating the amounts of light reflected from the 5 sample images and the 5 target images printed on the sample medium according to an embodiment of the present invention. The vertical axis of FIG. 6 denotes sensor output, and the horizontal axis denotes sample images and target images from darkest to lightest.

FIG. 7 is a graph illustrating an exemplary method of establishing an equation using the sample medium of FIG. 3 according to an embodiment of the present invention. The vertical axis of FIG. 7 denotes optical density, and the horizontal axis denotes sensor output. Specifically, FIG. 7 illustrates a curve which is formed using a curve fitting method based on the optical densities of the 5 sample images illustrated in FIG. 5 and the amounts of light reflected from the 5 sample images illustrated in FIG. 6. The following Equation (1) can be obtained from the curve illustrated in FIG. 7 is as follows:
y=0.000037x²+(−0.012572)x+1.576840 (1)
wherein x is the amount of light reflected from a predetermined image measured by the sensor 140, and y is an optical density of the predetermined image.

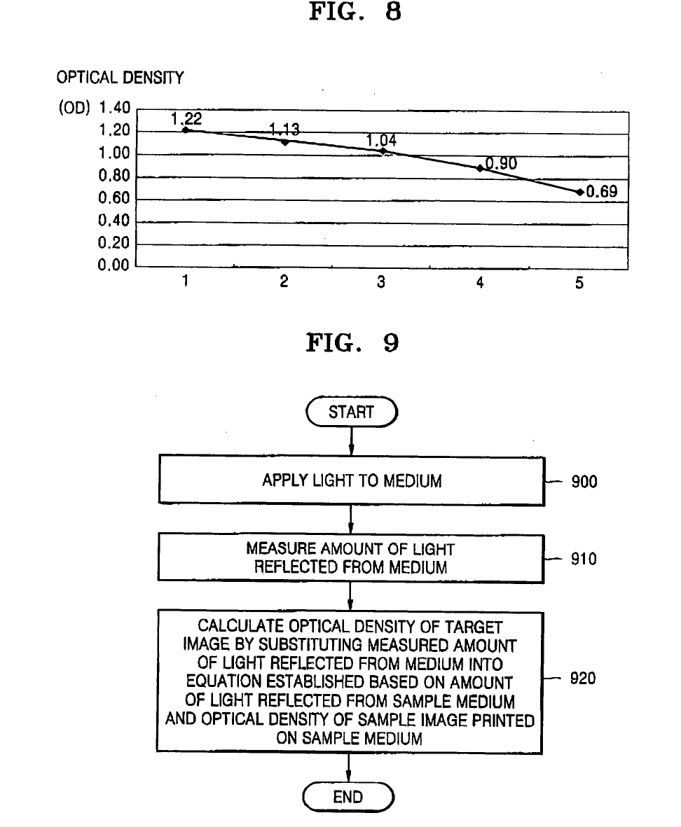

FIG. 8 is a graph illustrating exemplary optical densities calculated using Equation (1) above and the output values of the sensor 140 corresponding to the 5 target images illustrated in FIG. 6 according to an embodiment of the present invention. The vertical axis of FIG. 8 denotes optical density, and the horizontal axis denotes target images from darkest to lightest.

An exemplary method of measuring the optical density of an image printed on a medium according to embodiments of the present invention can be realized as computer-readable codes or instructions written on a computer-readable recording medium. The computer-readable recording medium may comprise any type of storage device on which data can be recorded in a computer-readable manner. Examples of computer-readable recording medium include ROM, RAM, CD-ROM, magnetic tape, floppy disc, optical data storage, and carrier wave (for example, data transmission through the Internet). The computer-readable recording medium can be distributed over a plurality of computer systems connected to a network so that data can be recorded thereon in a decentralized manner. Functional programs, codes, and code segments required for realizing embodiments of the present invention can be easily conceived by one of ordinary skill in the art.

As described above, according to embodiments of the present invention, it is possible to precisely measure the optical density of an image printed on a medium without the aid of an additional optical density measurement device by measuring the amount of light reflected from the medium, using a sensor generally already included in an image forming apparatus, and establishing an equation based on the measured amount of light reflected from the medium and the optical density of the image printed on the medium. Thus, it is possible to easily reduce or eliminate differences or variations in the quality of printing between image forming apparatuses.

While embodiments of the present invention have been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A method of measuring the optical density of an image printed on a medium, comprising the steps of:
reading reference information from a memory, wherein the reference information denotes a relationship between an amount of light reflected from a medium and an optical density of an image printed on the medium;
measuring an amount of light reflected from a medium on which a target image is printed by applying light to the medium; and
calculating an optical density of the target image using the reference information and the measured amount of light reflected from the medium.

2. The method of claim 1, wherein the reference information comprises an equation established based on the amount of light reflected from the medium and the optical density of the image printed on the medium.

3. The method of claim 1, wherein the reference information comprises a lookup table in which exemplary amounts of light reflected from a plurality of images printed on the medium and exemplary optical densities of the plurality of images are stored.

4. The method of claim 1, further comprising the steps of:
establishing an equation based on the amount of light reflected from the medium and the optical density of the image printed on the medium; and
storing the equation in the memory.

5. The method of claim 4, wherein the step of establishing the equation comprises the steps of:
measuring the amount of light reflected from a sample medium by applying light to the sample medium; and
establishing an equation based on the measured amount of light reflected from the sample medium and the optical density of a sample image printed on the sample medium.

6. The method of claim 4, wherein the step of establishing the equation comprises the steps of:
measuring the amount of light reflected from a sample medium by applying light to the sample medium on which sample images are printed;
measuring the optical density of the sample images; and
establishing an equation based on the measured amount of light reflected from the sample medium and the measured optical density of the sample images printed on the sample medium using a curve fitting method.

7. The method of claim 5, wherein the target image is printed in a region of the sample medium where no sample image is printed.

8. The method of claim 1, wherein the amount of light reflected from the medium is measured using a reflective optical sensor.

9. A computer program embodied on a computer-readable recording medium for measuring the optical density of an image printed on a medium, comprising:
a first set of instructions for directing a control unit to read reference information from a memory, wherein the reference information denotes a relationship between an amount of light reflected from a medium and an optical density of an image printed on the medium;
a second set of instructions for directing the control unit to measure an amount of light reflected from a medium on which a target image is printed by applying light to the medium; and
a third set of instructions for directing the control unit to calculate an optical density of the target image using the reference information and the measured amount of light reflected from the medium.

10. An apparatus for measuring the optical density of an image printed on a medium, comprising:
a sensor, for measuring an amount of light reflected from a medium on which a target image is printed by applying light to the medium;
a memory, for storing reference information denoting a relationship between the amount of light reflected from a medium and the optical density of an image printed on the medium; and
an optical density calculation unit, for calculating the optical density of the target image using the reference information and the measured amount of light reflected from the medium.

11. The apparatus of claim 10, wherein the reference information comprises an equation established based on the amount of light reflected from the medium and the optical density of the image printed on the medium.

12. The apparatus of claim 10, wherein the reference information comprises a lookup table in which exemplary amounts of light reflected from a plurality of images printed on the medium and exemplary optical densities of the plurality of images printed on the medium are stored.

13. The apparatus of claim 10, further comprising:
an equation generation unit, for establishing an equation based on the amount of light reflected from the medium and the optical density of the image printed on the medium and storing the equation in the memory.

14. The apparatus of claim 13, wherein the equation generation unit is configured to:
receive from the sensor the amount of light reflected from a sample medium measured by applying light to the sample medium; and
establish an equation based on the measured amount of light reflected from the sample medium and the optical density of a sample image printed on the sample medium.

15. The apparatus of claim 13, wherein the equation generation unit is configured to:
establish the equation based on the measured amount of light reflected from a sample medium and the optical density of a sample image printed on the sample medium.

16. The apparatus of claim 14, wherein the target image is printed in a region of the sample medium where no sample image is printed.

17. An image forming apparatus that prints an image on a medium, comprising:
a data input unit, for receiving image data to be printed;
a control unit, for generating a print control signal based on the received image data;
a print unit, for receiving the print control signal and the received image data and printing a target image on the medium; and
a sensor, for measuring an amount of light reflected from the medium by applying light onto the medium on which the target image has been printed,
wherein the control unit comprises:
a memory, for storing an equation established based on the amount of light reflected from a medium and the optical density of an image printed on the medium; and
an optical density calculator, for calculating the optical density of the target image using the equation stored in the memory and the measured amount of light reflected from the medium.

18. The image forming apparatus of claim 17, further comprising:
an equation generation unit, for receiving from the sensor the amount of light reflected from the medium and establishing an equation based on the measured amount of light reflected from the medium and the optical density of the image printed on the medium.

19. The image forming apparatus of claim 18, wherein the amount of light reflected from the medium is measured by applying light to the medium.
